(19) United States
(12) Patent Application Publication
(10) Pub. No.: US 2026/0244746 A1
(43) Pub. Date: Aug. 20, 2026

(54) HARDWARE-BASED METHOD FOR ENHANCING RESISTANCE AGAINST SIDE-CHANNEL ATTACKS IN A CRYPOSYSTEM

(71) Applicant: PQSECURE TECHNOLOGIES, LLC, BOCA RATON, FL (US)

(72) Inventors: Rami El Khatib, Boca Raton, FL (US); Abubakr Abdulgadir, Reston, VA (US)

(73) Assignee: PQSECURE TECHNOLOGIES, LLC, BOCA RATON, FL (US)

(21) Appl. No.: 18/852,303

(22) PCT Filed: Jun. 30, 2023
(86) PCT No.: PCT/US2023/026692

§ 371 Date: Sep. 27, 2024

(51) Int. Cl. G06F 21/55; G06F 21/60

(52) U.S. Cl. CPC G06F 21/556; G06F 21/602

(57) ABSTRACT

A hardware-based and software-based method for enhancing resistance against side-channel attacks in a cryptosystem that includes providing a current internal state memory with a segment of randomized data and operating within a cryptosystem, receiving leaky external data and the segment of randomized data from the current internal state memory at a randomizer module, and randomizing the leaky external data with the randomizer module utilizing the segment of randomized data from the current internal state memory to generate a randomized representation of the leaky external data as a data input for a crypto operation within the cryptosystem.

### FIELD OF THE INVENTION

The present invention is generally directed toward hardware-software and software-based methods and systems implemented in cryptosystems and, more particularly, is directed toward enhancements to side-channel resistance in cryptosystems.

### BACKGROUND OF THE INVENTION

Cryptography forms the key underpinning of various processing systems, working by encrypting communications based on complex mathematical problems. This intricate process is designed to keep private messages safe from third parties, helping to achieve data confidentiality, data integrity, authentication, and non-repudiation. Such protocols, comprising of cryptosystems, provide the foundation for implementing necessary security services. Despite the robust mathematical problems serving as the backbone of cryptography, they are not impervious to certain vulnerabilities. Specifically, when implementing cryptosystems, the inadvertent leakage of internal information poses a significant risk. Therefore, securing cryptosystems against side-channel leakage has become a critical necessity in modern digital infrastructure.

Side-channel analysis capitalizes on the unintended information leakage of a cryptosystem to uncover confidential information. Intrinsic emissions such as heat, power, or timing are inevitable during the implementation of cryptosystems, but their impact can be mitigated to such an extent that side-channel analysis becomes extremely difficult and resource-intensive. This is accomplished via side-channel countermeasures that amplify noise in these emissions or obscure the computations prone to leakage. While novel cryptosystems are continually being developed, the threat of unclear attack vectors loom large, prompting ongoing research to devise ways to combat side-channel analysis attacks while still maintaining competitive performance, power consumption, and area. Therefore, a need exists to overcome the problems with the prior art as discussed above.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a diagram depicting the a prior art for introducing a randomizing representation of leaky external data into the cryptosystem;

FIG. 2 is a diagram depicting another prior art for introducing a randomizing representation of leaky external data into the cryptosystem;

FIG. 3 is diagram depicting an embodiment of this invention for introducing a randomizing representation of leaky external data into the cryptosystem; and

FIG. 4 is a process flow diagram depicting a method for enhancing resistance against side-channel attacks in a cryptosystem in accordance with one embodiment of the present invention.

### SUMMARY OF THE INVENTION

The present invention provides a method to enhance side-channel resistance in a cryptosystems. The proposed method utilizes a randomizer module that leverages a segment of randomized data, drawn from the system's own internal state memory, to create a randomized representation of leaky external data that could potentially expose sensitive information. This strategy eliminates the reliance on an external random number generator, thereby enhancing the robustness of the system's security infrastructure. By making use of this internal segment of randomized data, the cryptosystem incurs less overhead compared to using an external random number generator.

With the foregoing and other objects in view, there is provided, in accordance with the invention, a computer processing system for enhancing resistance against side-channel attacks in a cryptosystem and that includes the steps of providing a current internal state memory with a segment of randomized data and operating within a cryptosystem, receiving leaky external data and the segment of randomized data from the current internal state memory at a randomizer module, and randomizing the leaky external data with the randomizer module utilizing the segment of randomized data from the current internal state memory to generate a randomized representation of the leaky external data as a data input for a crypto operation within the cryptosystem.

In one embodiment of the present invention, the process may include utilizing the segment of randomized data from the current internal state memory with a random number generator.

In yet another embodiment of the present invention, the process may include providing a secondary interface handling a pre-randomized representation of the leaky external data as the data input for the crypto operation within the cryptosystem, wherein the randomization of the leaky external data with the randomizer module utilizing the segment of randomized data from the current internal state memory is a primary interface. In one embodiment, the primary interface and the secondary interface share at least one module. The current internal state memory and the leaky external data are from different invocations of the cryptosystem.

In one embodiment of the present invention, the process may include subjecting the segment of randomized data to a mathematical function.

In one embodiment of the present invention, the process includes the cryptosystem being operably configured to perform at least one hashing algorithm.

In a further embodiment of the present invention, the process may include the at least one hashing algorithm including SHA-3 or its derivatives.

In an additional embodiment of the present invention, the process may include the cryptosystem including and utilizing a Keccak algorithm.

Although the invention is illustrated and described herein as embodied in a hardware-based and software-based method for enhancing resistance against side-channel attacks in a cryptosystem, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a method that eliminates the requirement for an external random generator for side-channel purposes by leveraging a cryptosystem's internal state memory to generate randomized data.

In the context of this invention, a cryptosystem pertains to any hardware or software cryptographic system that implements a cryptographic algorithm and possesses the capability to generate random intermediate data. Here, the term “intermediate” refers to any stage in an algorithm, including the final step. Random intermediate data is indicative of data that appears unintelligible from the input and cannot be reverted to the input without access to a portion of the input. Representative examples of cryptosystems may encompass systems that execute hashing algorithms like SHA-2, SHA-3, or symmetric key algorithms such as AES or ChaCha20.

In the context of this invention, the internal state memory is a storage unit that preserves intermediate data utilized by an algorithm in the cryptosystem. Since the cryptosystem generates random intermediate data, the internal state memory provides a segment of randomized data. This segment could encompass the entire internal state memory or merely a portion of it.

In the context of this invention, external data is an input data intended for processing by a crypto operation in the cryptosystem. A crypto operation pertains to a step or a sequence of steps in an algorithm, facilitated by the cryptosystem and performed on some data therein. The input data could be entirely external to the cryptosystem, internal to the cryptosystem but external to a subsystem within the cryptosystem, or a combination of both. For instance, the SHA-3 algorithm comprises a sub-algorithm known as Keccak. Keccak can be viewed as an internal subsystem of SHA-3. The input to Keccak within SHA-3 accepts the input of SHA-3 as well as a padding input generated internally by SHA-3. Both the input of SHA-3 and the padding would be regarded as external data in the context of this invention.

A prevalent technique to supplement side-channel countermeasures for a cryptosystem involves providing a randomized representation of any data that may potentially leak information. For example, leaky data can be portrayed by two shares of data whose sum equates to the original leaky data. This representation is not limited to two shares; one can implement three, four, or a higher number of shares as long as the shares represent the original data through some computation. It is widely recognized that the more shares there are, the higher the level of security against side-channel attacks.

In the context of this invention, a randomizer module is a unit capable of producing a randomized representation of an input data by leveraging some random data. For instance, a two-share randomizer module, given input data x and random data r, generates two share data a1 and a2 where a1=r and a2=x XOR r. The data a1 and a2 continue to represent the original data x through x=a1 XOR a2. By feeding the cryptosystem data a1 and a2, the computation within the cryptosystem should leak less information. The aforementioned example is merely one of many potential strategies to create a two-share randomizer module. Similar strategies can be adopted to create a randomizer module that outputs a higher number of shares representing the input data.

In the context of this invention, a leaky external data is external data that may leak information potentially useful for side-channel attacks. Conversely, non-leaky external data is external data which does not leak information. A cryptosystem must possess leaky external data and may or may not include non-leaky external data. The primary focus of this invention is on the leaky external data and there will be no discussion regarding the processing of non-leaky external data. Nonetheless, the cryptosystem can accept non-leaky external data through a shared interface or a separate interface with leaky external data. In this case, interface refers to a shared boundary across which two separate components of a computer system exchange information. The exchange may occur between software, computer hardware, peripheral devices, or a combination of these. The interface may incorporate certain hardware or software modules to facilitate the information exchange.

To safeguard the cryptosystem against side-channel attacks, a randomized representation of the leaky external data should be introduced to the cryptosystem prior to its processing by a crypto operation within the cryptosystem.

Without compromising the fundamental nature of this invention, a developer of a cryptosystem may opt to employ a different side-channel countermeasure technique on a portion of the leaky data or may decide not to utilize any technique on the leaky data. In simpler terms, the developer may elect not to employ the randomized representation technique on a section of the leaky data. From the standpoint of this invention, this part of the leaky data, on which the developer chose not to use the randomized representation technique, is assumed to be non-leaky external data as previously defined.

Moreover, a developer of a cryptosystem may opt to use the randomized representation technique on non-leaky data, if feasible. While this decision may seem counter-intuitive, it might alleviate the need to establish multiple interfaces and/or duplicate components of the system. From the standpoint of this invention, this part of the non-leaky data, on which the developer decided to use the randomized representation technique, is presumed to be leaky external data.

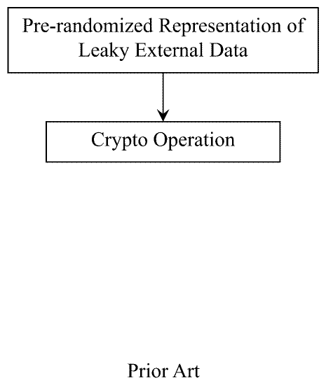

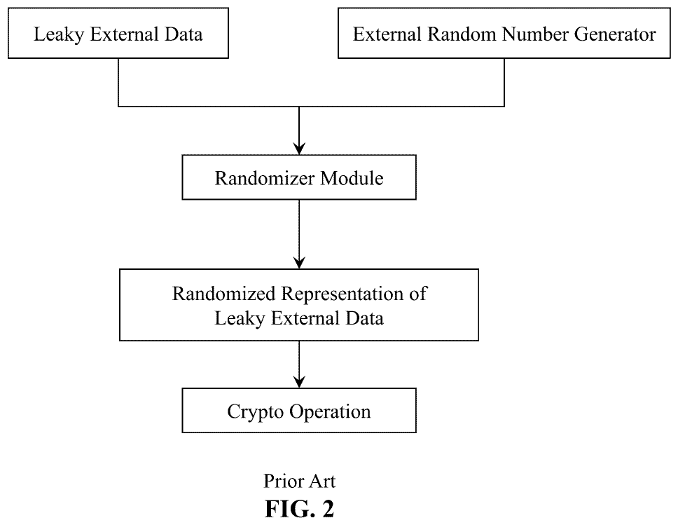

FIGS. 1-2 depict prior art systems, wherein a randomized representation of the leaky external data is integrated into the cryptosystem. In FIG. 1, the strategy involves generating the randomized representation of the leaky external data outside the cryptosystem before introducing it into the cryptosystem.

In FIG. 2, the strategy is to employ a randomizer module with an external random number generator to generate the randomized representation of the leaky external data. In other words, the leaky external data introduced into the cryptosystem is first fed into the randomizer module, which is utilizing an external random number generator, to generate a randomized representation of the leaky external data before executing a crypto operation.

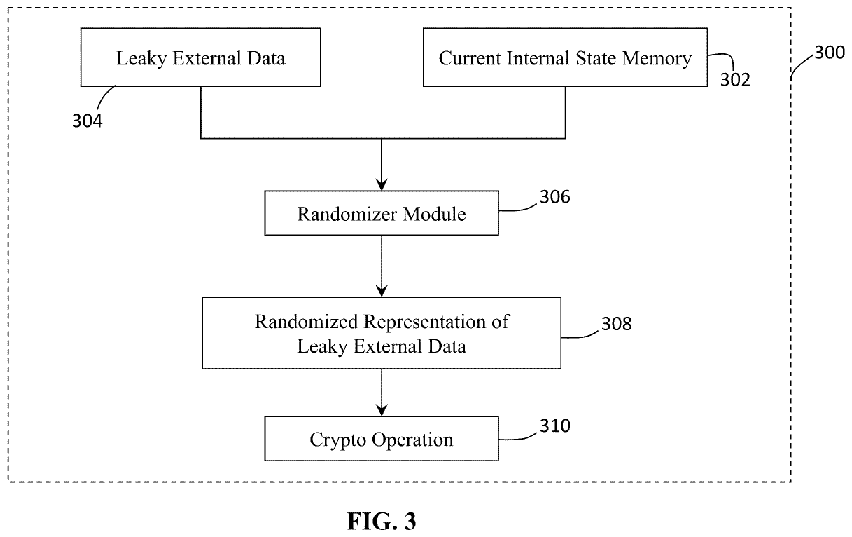

The embodiment of this invention is illustrated in FIG. 3. The strategy mirrors that used in FIG. 2 with a variation (that may, in some embodiments, the only variation). An external random number generator is substituted by a segment of randomized data from the current internal state memory 302. In other words, the leaky external data 304 is introduced (reproduced with an arrow) into the cryptosystem 300 is first fed into the randomizer module 306, which is utilizing a segment of randomized data (represented with an arrow) from the current internal state memory 302 to generate a randomized representation of the leaky external data 308 before executing a crypto operation 310.

The current internal state memory 302 indicates the present data in the internal state memory. This may be introduced in a form of progression. A segment of randomized data from the current internal state memory 302 is exposed to the randomizer unit. The randomizer unit uses this segment of randomized data to generate the randomized representation of the leaky external data from the leaky external data. Subsequently, the randomized representation of the leaky external data is processed by the crypto operation which will eventually update the segment of the internal state memory. The updated segment of the internal state memory becomes the segment of randomized data from the current internal state memory for the next incoming leaky external data.

The main advantage of using the internal state memory instead of an external random number generator is the elimination of the overhead required by the external random number generator. For hardware, this reduces the area of the cryptosystem by eliminating the need for a dedicated random number generator. For software, there would be fewer calls to the random number generator function. Regardless, the process produces a lower memory footprint and more effectively and efficiently enhances side-channel resistance in cryptosystems.

Without compromising the fundamental nature of this invention, the randomizer module may use a combination of external random number generator as presented by the method in FIG. 2 and the internal state memory as depicted by the method in FIG. 3 to generate the randomized representation of the leaky external data. One instance, though not the only one, is when the randomizer module requires more random data than what the segment of randomized data from the current internal state memory provides.

The cryptosystem may receive a combination of leaky external data and pre-randomized representation of leaky external data. Without compromising the fundamental nature of this invention, the cryptosystem can process the leaky external data using the randomizer module as depicted by the method in FIG. 3, and the pre-randomized representation of leaky external data as presented by the method in FIG. 1. This can be accomplished via completely separate interfaces or shared interfaces where certain modules are shared.

Within the context of this invention, an invocation of the cryptosystem denotes a call to the cryptosystem to execute a single cryptographic algorithm. For instance, hashing a message equates to a single invocation. Hashing another message constitutes another invocation.

During the first loading of the leaky external data in an invocation of the cryptosystem, the segment of randomized data from the current internal state memory is derived from a previous invocation of the cryptosystem. With the present invention, this is not a problem. Without compromising the fundamental nature of this invention, it is possible for the randomizer module to receive leaky external data and randomized segment of the current internal state memory from different invocations of the cryptosystem.

Initial seeding might be required for the cryptosystem to randomize the segment of the internal state memory for the very first invocation of the cryptosystem. It should be assumed that the segment of randomized data in the internal state memory has been randomized either through the crypto operation or through some other means. In essence, it is assumed that at the moment the randomizer module needs to randomize the leaky external data, the current internal state memory possesses a segment of randomized data.

Without compromising the fundamental nature of this invention, the segment of randomized data from the current internal state memory can undergo some mathematical function prior to being introduced to the randomizer module. In this context, a mathematical function refers to a process that transforms an input into an output. For instance, a linear feedback shift register (LFSR) can be perceived as a mathematical function on an input.

As previously mentioned, a hashing algorithm is a cryptographic algorithm that can generate random data. A common hashing algorithm is SHA-3, which is a family of algorithms defined by NIST in FIP202. This includes SHAKE128 and SHAKE256 extendable output functions and SHA3-224, SHA3-256, SHA3-384, and SHA3-512 hash functions. Moreover, derivatives of SHA-3 such as cSHAKE, KMAC, TupleHash, and ParallelHash are defined in NIST SP 800-185. The cryptographic community might devise additional derivative works of SHA-3 not specified here. To this extent, this invention covers any cryptosystem that utilizes SHA-3 or any current or future derivatives.

SHA-3 and its derivatives utilize the Keccak algorithm, which is defined by Team Keccak. To this extent, this invention covers any cryptosystem that utilizes the Keccak algorithm.

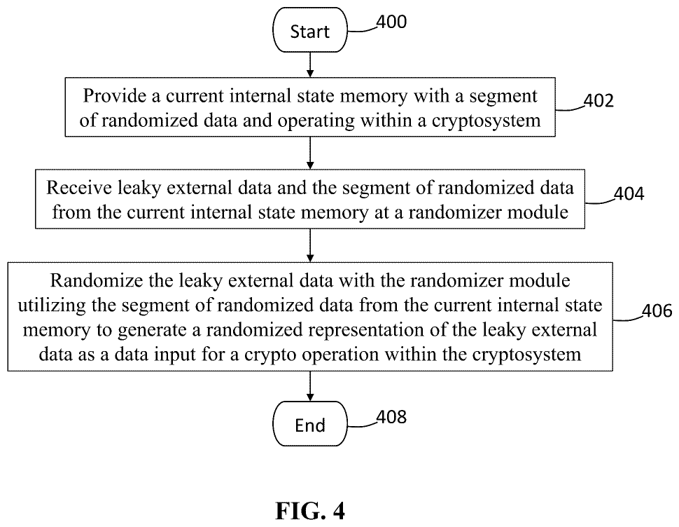

With reference to FIG. 4, the present invention can be seen depicted in a process flow diagram. Specifically, the method for enhancing resistance against side-channel attacks in a cryptosystem. FIG. 3 may also be viewed in conjunction with the process flow chart of FIG. 4. Although FIG. 4 shows a specific order of executing the process steps, the order of executing the steps may be changed relative to the order shown in certain embodiments. Also, two or more blocks shown in succession may be executed concurrently or with partial concurrence in some embodiments. Certain steps may also be omitted in FIG. 4 for the sake of brevity. In some embodiments, some or all of the process steps included in FIG. 4 can be combined into a single process.

The process starts at step 400 and immediately proceeds to step 402 of providing a current internal state memory with a segment of randomized data and operating within a cryptosystem. The process may proceed to step 404 of receiving leaky external data and the segment of randomized data from the current internal state memory at a randomizer module and then proceed to step 406 of randomizing the leaky external data with the randomizer module utilizing the segment of randomized data from the current internal state memory to generate a randomized representation of the leaky external data as a data input for a crypto operation within the cryptosystem. In one embodiment, the process includes utilizing the segment of randomized data from the current internal state memory with a random number generator and providing a secondary interface handling a pre-randomized representation of the leaky external data as the data input for the crypto operation within the cryptosystem. The randomization of the leaky external data with the randomizer module that utilizes the segment of randomized data from the current internal state memory is a primary interface. The primary interface and the secondary interface may also share at least one module between them. The process may terminate at step 408.

In one embodiment, the current internal state memory and the leaky external data are from different invocations of the cryptosystem. Further, the segment of randomized data may be subjected to a mathematical function. The cryptosystem is preferably operably configured to perform at least one hashing algorithm as well.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above-described features.

What is claimed is:

1. A hardware-based and software-based method for enhancing resistance against side-channel attacks in a cryptosystem comprising:
providing a current internal state memory with a segment of randomized data and operating within a cryptosystem;
receiving leaky external data and the segment of randomized data from the current internal state memory at a randomizer module; and
randomizing the leaky external data with the randomizer module utilizing the segment of randomized data from the current internal state memory to generate a randomized representation of the leaky external data as a data input for a crypto operation within the cryptosystem.

2. The hardware-based and software-based method according to claim 1, further comprising:
utilizing the segment of randomized data from the current internal state memory with a random number generator.

3. The hardware-based and software-based method according to claim 1, further comprising:
providing a secondary interface handling a pre-randomized representation of the leaky external data as the data input for the crypto operation within the cryptosystem, wherein the randomization of the leaky external data with the randomizer module utilizing the segment of randomized data from the current internal state memory is a primary interface.

4. The hardware-based and software-based method according to claim 3, wherein the primary interface and the secondary interface share at least one module.

5. The hardware-based and software-based method according to claim 1, wherein the current internal state memory and the leaky external data are from different invocations of the cryptosystem.

6. The hardware-based and software-based method according to claim 1, further comprising:
subjecting the segment of randomized data to a mathematical function.

7. The hardware-based and software-based method according to claim 1, wherein the cryptosystem is operably configured to perform at least one hashing algorithm.

8. The hardware-based and software-based method according to claim 5, wherein the at least one hashing algorithm includes SHA-3 or its derivatives.

9. The hardware-based and software-based method according to claim 1, wherein the cryptosystem includes a Keccak algorithm.
